(19) United States
(12) Patent Application Publication
(10) Pub. No.: US 2021/0024309 A1
(43) Pub. Date: Jan. 28, 2021

(54) PAPER FEED MECHANISM AND IMAGE FORMING APPARATUS

(71) Applicant: Konica Minolta Technology Development (WUXI) Co., Ltd., Wuxi (CN)

(72) Inventors: Peng ZHOU, Wuxi (CN); Cunlu WEI, Wuxi (CN)

(73) Assignee: Konica Minolta Technology Development (WUXI) Co., Ltd., Wuxi (CN)

(21) Appl. No.: 16/928,100

(22) Filed: Jul. 14, 2020

(30) Foreign Application Priority Data
Jul. 26, 2019 (CN) 201910681408.2

(51) Int. Cl. B65H 3/14; G03G 15/00; B65H 5/22; B65H 7/16

(52) U.S. Cl. CPC B65H 3/14; B65H 7/16; B65H 5/222; G03G 15/6511

(57) ABSTRACT

A paper feed mechanism includes: a paper storage to store sheets of paper; an air blowing unit disposed on each of both sides of the paper storage in a second direction orthogonal to a first direction corresponding to a paper conveyance direction, in which the air blowing unit blows air to a side end of each of the sheets of paper in the paper storage to float one or some of the sheets of paper in the paper storage; and a paper conveyance unit disposed above the paper storage, in which the paper conveyance unit holds, by suction, an uppermost sheet of paper among the floated sheets of paper, and conveys the uppermost sheet of paper. An air blowing position of the air blowing unit is changeable in the first direction according to information about the sheets of paper.

The entire disclosure of Chinese Patent Application No. 201910681408.2, filed on Jul. 26, 2019, is incorporated herein by reference in its entirety.

### BACKGROUND

### Technological Field

The present disclosure relates to a paper feed mechanism and an image forming apparatus, and particularly to a paper feed mechanism and an image forming apparatus, by which an air blowing position of an air blowing unit can be adjusted based on information about different types of sheets of paper stored in a paper storage.

### Description of the Related Art

Conventionally, an image forming apparatus generally includes a paper feed mechanism, a conveyance unit, a fixing mechanism, and the like. Sheets of paper are stored in a paper storage of the paper feed mechanism. When printing or copying of a sheet of paper in the paper storage is required, an air blowing unit in the paper feed mechanism blows air to the paper storage, to thereby cause some of the sheets of paper in the paper storage to be floated and separated from each other. At the same time, the paper conveyance unit can hold one of the floated sheets of paper by suction and convey the one sheet of paper to the conveyance unit. Then, the conveyance unit conveys the one sheet of paper to the fixing mechanism, which then fixes a toner image onto the one sheet of paper. Further, the conveyance unit conveys the sheet of paper having the toner image fixed thereto toward a paper discharge tray.

### SUMMARY

In general, the paper storage can contain sheets of paper having different pieces of information (different lengths, different thicknesses, and different types). In the conventional technique, however, the air blowing position of the air blowing unit is fixed, i.e., the air blowing position of the air blowing unit is constant. Thus, even when the paper information changes, the air blowing position of the air blowing unit cannot be changed in accordance with such a change in the paper information. Accordingly, the sheets of paper may float insufficiently, which consequently leads to problems that sheets of paper may be conveyed at insufficient speed, sheets of paper may be successively re-fed (two or more overlapping sheets of paper may be conveyed), no sheets of paper may be fed, and the like.

Thus, Japanese Laid-Open Patent Publication No. 2013-82510 employs the following technical proposal. Specifically, the direction of the air outlet of the air blowing unit is changed as required, and thereby the direction of the blowing air can be changed. This however still cannot completely solve the above-described problems.

To achieve at least one of the above-mentioned objects, according to an aspect of the present invention, a paper feed mechanism reflecting one aspect of the present invention comprises: a paper storage to store sheets of paper; an air blowing unit disposed on each of both sides of the paper storage in a second direction orthogonal to a first direction corresponding to a paper conveyance direction, in which the air blowing unit blows air to a side end of each of the sheets of paper in the paper storage to float one or some of the sheets of paper in the paper storage; and a paper conveyance unit disposed above the paper storage, in which the paper conveyance unit holds, by suction, an uppermost sheet of paper among the floated sheets of paper, and conveys the uppermost sheet of paper. An air blowing position of the air blowing unit is changeable in the first direction according to information about the sheets of paper.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic diagram showing an image forming apparatus of the present disclosure.

FIG. 2 is a perspective configuration diagram showing one example of a paper feed mechanism of the present disclosure.

FIG. 3A is a schematic side view of the paper feed mechanism shown in FIG. 2 in the case where an air blowing unit is located at a position that is different in accordance with sheets of paper having different lengths.

FIG. 3B is a schematic side view of the paper feed mechanism shown in FIG. 2 in the case where the air blowing unit is located at a position that is different in accordance with sheets of paper having different lengths.

FIG. 3C is a schematic side view of the paper feed mechanism shown in FIG. 2 in the case where the air blowing unit is located at a position that is different in accordance with sheets of paper having different lengths.

FIG. 4 is a perspective configuration diagram showing another example of the paper feed mechanism of the present disclosure.

FIG. 5A is a schematic side view of the paper feed mechanism shown in FIG. 4 in the case where air blowing units are located at positions that are different in accordance with sheets of paper having different lengths.

FIG. 5B is a schematic side view of the paper feed mechanism shown in FIG. 4 in the case where the air blowing units are located at positions that are different in accordance with sheets of paper having different lengths.

FIG. 5C is a schematic side view of the paper feed mechanism shown in FIG. 4 in the case where the air blowing units are located at positions that are different in accordance with sheets of paper having different lengths.

FIG. 6A is a schematic diagram showing the relation between a length of each sheet of paper in a paper storage and a position of the air blowing unit in the paper feed mechanism of the present disclosure.

FIG. 6B is a schematic table showing the relation among a length and a basis weight of each sheet of paper in the paper storage, and a position and an air blowing amount of the air blowing unit in the paper feed mechanism of the present disclosure.

FIG. 7A is a perspective configuration diagram showing the case where the air blowing unit in the paper feed mechanism of the present disclosure has a plurality of air blowing ports.

FIG. 7B is a perspective configuration diagram showing the case where the air blowing unit in the paper feed mechanism of the present disclosure has a plurality of air blowing ports.

FIG. 8 is a flowchart illustrating the operation for printing or copying performed by each component in the paper feed mechanism of the image forming apparatus of the present disclosure.

### DETAILED DESCRIPTION OF EMBODIMENTS

Hereinafter, one or more embodiments of the present invention will be described with reference to the drawings. However, the scope of the invention is not limited to the disclosed embodiments.

Preferable embodiments will be hereinafter described in detail with reference to the accompanying drawings. Furthermore, the description of these embodiments allow a person skilled in the art to implement various alternative methods. Also, the present invention is not limited to the preferable embodiments described herein. The above-mentioned embodiments may be combined in any way as required and modified variously within the scope of the technical idea of the present invention.

<Entire Configuration of Image Forming Apparatus>

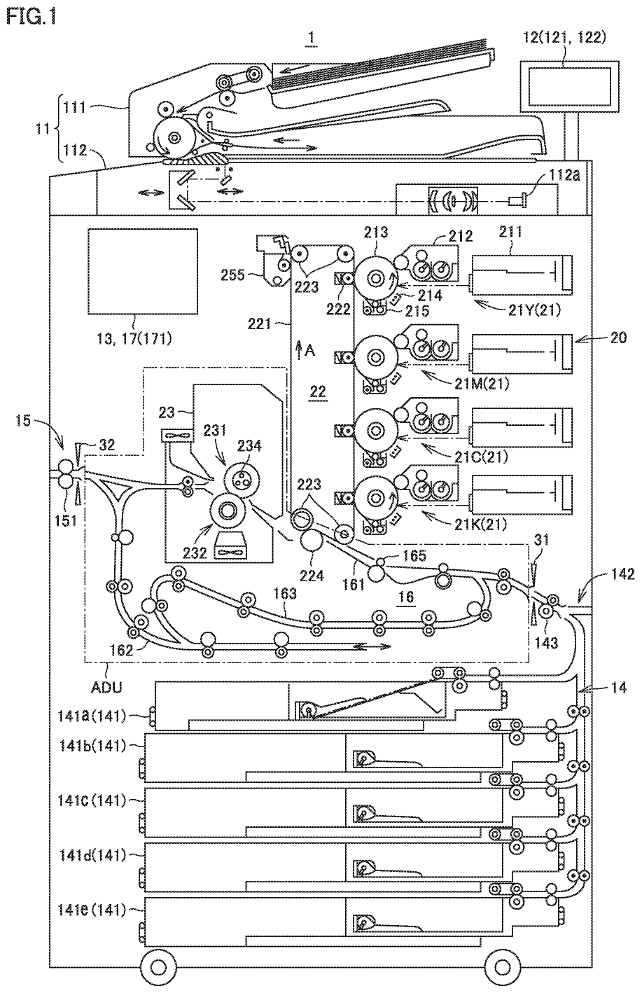

First, the entire configuration of an image forming apparatus according to the present disclosure will be hereinafter described. FIG. 1 is a schematic diagram showing an image forming apparatus of the present disclosure. Image forming apparatus 1 primarily transfers toner images of colors of yellow (Y), magenta (M), cyan (C), and black (K) that are formed on respective photoconductor drums 213 onto an intermediate transfer belt 221, on which toner images of four colors are superimposed on one another, and then secondarily transferred onto a sheet of paper to thereby form an image.

As shown in FIG. 1, image forming apparatus 1 generally includes an image reading unit 11, an operation display unit 12, an image processing unit 13, an image forming unit 20, a paper feed mechanism 14, a paper discharge mechanism 15, a conveyance unit 16, and a controller 17.

Controller 17 includes a central processing unit (CPU), a read only memory (ROM), a random access memory (RAM), and the like, and comprehensively controls the operations of the blocks in image forming apparatus 1. Through a communication unit (not shown), controller 17 transmits and receives various types of data to and from an external device (for example, a personal computer) connected to a communication network such as a local area network (LAN) and a wide area network (WAN).

Image reading unit 11 includes an automatic document feeding device 111 also called an auto document feeder (ADF), a document image reading device 112 (a scanner), and the like.

Automatic document feeding device 111 causes a conveyance mechanism to convey a document placed on a document tray to be fed to document image reading device 112. Document image reading device 112 optically scans the document conveyed from automatic document feeding device 111 onto a contact glass or the document placed on the contact glass, and then, directs the light reflected from the document onto a light-receiving surface of a charge coupled device (CCD) sensor 112a so as to form an image. Then, document image reading device 112 reads the image on the document. Image reading unit 11 generates input image data based on the result read by document image reading device 112. Image processing unit 13 subjects the input image data to prescribed image processing.

Operation display unit 12 is formed of a liquid crystal display (LCD) equipped with an operation panel, for example, and functions as a display unit 121 and an operation unit 122. According to a display control signal input from controller 17, display unit 121 displays various types of operation screens, states of the image, operation states of each function, and the like. Operation unit 122 includes various types of operation keys such as numeric keys and a start key. Operation unit 122 receives various types of operations input by a user and outputs an operation signal to controller 17. The user can operate operation display unit 12 to make settings for image formation, such as a document setting, an image quality setting, a magnification setting, an application setting, an output setting, a setting for single-sided/double-sided printing, and a paper setting.

Image processing unit 13 includes a circuit and the like for subjecting the input image data to digital image processing for the initial setting or the user setting. For example, image processing unit 13 performs tone correction based on the tone correction data under the control of controller 17. Furthermore, image processing unit 13 subjects the input image data to various correction processing such as color correction and shading correction. Image forming unit 20 is controlled based on the image data obtained by performing the processing mentioned above.

Image forming unit 20 includes: a toner image forming unit 21 that forms a toner image based on color toners of a Y component, an M component, a C component, and a K component according to the input image data; an intermediate transfer unit 22 that transfers the toner image formed by toner image forming unit 21 onto a sheet of paper; a fixing mechanism 23 that fixes the transferred toner image to the sheet of paper; and the like.

Toner image forming unit 21 is formed of four toner image forming units 21Y, 21M, 21C, and 21K for a Y component, an M component, a C component, and a K component, respectively. Since toner image forming units 21Y, 21M, 21C, and 21K have the same configuration, the same components will be denoted by the same reference characters for the convenience of illustration and explanation, and the components that need to be distinguished from each other will be denoted by reference characters with suffixes Y, M, C, and K. In FIG. 1, only the components of toner image forming unit 21Y for a Y component are denoted by reference characters, whereas the components of other toner image forming units 21M, 21C, and 21K are not denoted by reference characters.

Toner image forming unit 21 includes an exposure device 211, a developing device 212, a photoconductor drum 213, a charging device 214, a drum cleaning device 215, and the like.

Photoconductor drum 213 is a negatively-charged organic photo-conductor (OPC) formed, for example, by sequentially stacking an under coat layer (UCL), a charge generation layer (CGL), and a charge transport layer (CTL) on the outer circumferential surface of an electrically-conductive cylindrical body made of aluminum (a pipe made of an aluminum material).

Charging device 214 is formed of a corona discharge generator such as a grid-control corona charging device or a corona tube charging device, for example By corona discharge, charging device 214 charges the surface of photoconductor drum 213 similarly with negative polarity.

Exposure device 211 is formed, for example, of: a light emitting diode (LED) array including a plurality of LEDs linearly arranged; an LPH drive unit (a driver IC) for driving each LED; and an LED print head including a lens array and the like for directing light reflected from the LED array to photoconductor drum 213 so as to form an image thereon. One LED in the LED array corresponds to one point on the image. Controller 17 controls the LPH drive unit to cause a prescribed drive current to flow through the LED array, to thereby allow a specific LED to emit light.

Exposure device 211 irradiates photoconductor drum 213 with light corresponding to the image of each color component. Positive electric charge generated in the charge generation layer of photoconductor drum 213 as a result of light irradiation is transferred onto the surface of the charge transport layer to neutralize the surface charge (negative electric charge) on photoconductor drum 213. Thereby, an electrostatic latent image of each color component is formed on the surface of photoconductor drum 213 by the electric potential difference from the surroundings.

Developing device 212 contains a developer for each color component (for example, a two-component developer formed of toner and magnetic carriers). Developing device 212 causes the toner of each color component to adhere to the surface of photoconductor drum 213, thereby visualizing the electrostatic latent image to form a toner image. Specifically, a developing bias voltage is applied to a developer carrier (a developing roller) to thereby produce an electric field between photoconductor drum 213 and the developer carrier. By the electric potential difference between photoconductor drum 213 and the developer carrier, the electrically charged toner on the developer carrier is moved to adhere to the exposure portion on the surface of photoconductor drum 213.

Drum cleaning device 215 includes a drum cleaning blade and the like that are in sliding contact with the surface of photoconductor drum 213, and serves to remove the post-transfer remaining toner that remains on the surface of photoconductor drum 213 after primary transfer.

Intermediate transfer unit 22 includes an intermediate transfer belt 221, a primary transfer roller 222, two or more support rollers 223, a secondary transfer roller 224, a belt cleaning device 225, and the like.

Intermediate transfer belt 221 is formed of an endless belt and passes over the plurality of support rollers 223 in an endless manner. At least one of the plurality of support rollers 223 is a driving roller while other support rollers 223 are driven rollers. The driving roller is rotated to cause intermediate transfer belt 221 to move in the direction indicated by an arrow A at a prescribed speed.

Primary transfer roller 222 is disposed to face photoconductor drum 213 of each color component and located on the inner circumferential surface side of intermediate transfer belt 221. Primary transfer roller 222 is pressed into contact with photoconductor drum 213 with intermediate transfer belt 221 sandwiched therebetween, thereby forming a primary transfer nip portion (hereinafter referred to as a “primary transfer portion”) at which the toner image is transferred from photoconductor drum 213 onto intermediate transfer belt 221.

Secondary transfer roller 224 is disposed to face one of the plurality of support rollers 223 and located on the outer circumferential surface side of intermediate transfer belt 221. Each support roller 223 located to face intermediate transfer belt 221 will be referred to as a support roller. Secondary transfer roller 224 is pressed into contact with the support roller with intermediate transfer belt 221 sandwiched therebetween, thereby forming a secondary transfer nip portion (hereinafter referred to as a “secondary transfer portion”) at which the toner image is transferred from intermediate transfer belt 221 onto a sheet of paper.

In the primary transfer portion, the toner images on photoconductor drums 213 are sequentially superimposed on one another into one toner image and primarily transferred onto intermediate transfer belt 221. Specifically, a primary transfer bias voltage is applied to primary transfer roller 222, and electric charge that is opposite in polarity to the toner is applied to the lower surface side of intermediate transfer belt 221 (the side coming into contact with primary transfer roller 222). Thereby, the toner image is electrostatically transferred onto intermediate transfer belt 221.

Then, while a sheet of paper passes through the secondary transfer unit, the toner image on intermediate transfer belt 221 is secondarily transferred onto the sheet of paper.

Specifically, when a secondary transfer bias voltage is applied to secondary transfer roller 224, electric charge that is opposite in polarity to the toner is applied to the lower surface side of the sheet of paper (the side coming into contact with secondary transfer roller 224). Thereby, the toner image is electrostatically transferred onto the sheet of paper. The sheet of paper onto which the toner image is transferred is then conveyed toward fixing mechanism 23.

Belt cleaning device 225 includes a belt cleaning blade and the like that are in sliding contact with the surface of intermediate transfer belt 221, and serves to remove the post-transfer remaining toner that remains on the surface of intermediate transfer belt 221 after secondary transfer.

Intermediate transfer unit 22 may employ the configuration in which a secondary transfer belt passes over, in place of secondary transfer roller 224, a plurality of support rollers including a secondary transfer roller in an endless manner (a so-called belt-type secondary transfer unit).

Fixing mechanism 23 includes: a heating unit 231 serving to heat a sheet of paper and disposed on one side of a paper conveyance path, i.e., on the side of a surface of the sheet of paper onto which the toner image is fixed (the surface on which a toner image is formed); a pressing unit 232 serving to press a sheet of paper against heating unit 231 and disposed on the other side of the paper conveyance path, i.e., on the side of a back surface of the sheet of paper (on the surface opposite to the surface onto which the toner image is fixed); a heat source 234 serving to heat heating unit 231; and the like. The sheet of paper having the toner image secondarily transferred thereon and conveyed along the paper conveyance path is heated and pressurized while it passes through fixing mechanism 23. Thereby, the toner image is fixed onto the sheet of paper.

Paper feed mechanism 14 includes a paper storage 141 and a manual paper feed mechanism 142. Furthermore, paper feed mechanism 14 includes a paper feed roller unit 143 and the like and serves to feed a sheet of paper, which has been supplied from paper storage 141 or manual paper feed mechanism 142, to conveyance unit 16.

Paper discharge mechanism 15 includes a paper discharge roller unit 151 and the like, and serves to discharge the sheet of paper fed from conveyance unit 16 to the outside of the apparatus.

Conveyance unit 16 includes a main conveyance unit 161, a steering conveyance unit 162, a conveyance unit for backside-printing 163, a paper path switching unit (not shown), and the like. A part of conveyance unit 16 is incorporated in one unit, for example, together with fixing mechanism 23 and detachably attached to image forming apparatus 1 (a paper conveyance unit ADU).

Main conveyance unit 161 includes, as paper conveyance elements that sandwich a sheet of paper for conveyance, a plurality of conveyance roller units including an inlet roller unit 165 that is disposed in the secondary transfer unit on its upstream side in the paper conveyance direction. Main conveyance unit 161 conveys a sheet of paper supplied from paper storage 141 or a sheet of paper supplied through manual paper feed mechanism 142 so as to pass through image forming unit 20 (the secondary transfer unit and fixing mechanism 23). Then, main conveyance unit 161 conveys the sheet of paper fed from image forming unit 20 (fixing mechanism 23) toward paper discharge mechanism 15.

Steering conveyance unit 162 temporarily stops the sheet of paper fed from fixing mechanism 23, reverses the conveyance direction, and then conveys the sheet of paper to paper discharge mechanism 15 or conveyance unit for backside-printing 163.

Conveyance unit for backside-printing 163 serves as a circulation path along which the sheet of paper steered by steering conveyance unit 162 is conveyed to main conveyance unit 161. Through main conveyance unit 161, the sheet of paper passes in the state where its second surface (back surface) faces upward as an upper surface.

The paper path switching unit (not shown) discharges the sheet of paper fed from fixing mechanism 23 as it is, or reverses the sheet of paper and discharges the reversed sheet of paper, or conveys the sheet of paper to conveyance unit for backside-printing 163 and switches the paper path. Specifically, controller 17 controls the operation of the paper path switching unit based on the processing details of image formation processing (single-sided/double-sided printing, paper discharge in face-up/face-down states, and the like).

<Specific Configuration of Paper Feed Mechanism>

The following is an explanation about a specific configuration of the paper feed mechanism of the present disclosure with reference to FIGS. 1 to 5C.

Paper feed mechanism 14 mainly includes a paper storage 141 and a paper conveyance unit 144. In paper storage 141, sheets of paper aa stacked in a paper bundle are stored. Paper conveyance unit 144 is located above the paper bundle, and can hold an uppermost sheet of paper aa of the paper bundle by suction, and can convey sheet of paper aa held by suction to conveyance unit 16 in a first direction x (the paper conveyance direction, the length direction of the sheet of paper).

Paper feed mechanism 14 further includes at least one pair of air blowing units. One pair of air blowing units are configured such that two air blowing units 18 are disposed on respective ones of both sides of paper storage 141 to extend in a second direction y orthogonal to first direction x (i.e., in the width direction of each sheet of paper). Air blowing unit 18 has an air outlet through which it blows air. Two air outlets are disposed on respective ones of both sides of paper storage 141. Two air blowing units 18 can blow air into paper storage 141 (can blow air toward the paper bundle). The air blowing direction is perpendicular to the side surface of the paper bundle (i.e., air is blown in second direction y). Thereby, some of upper sheets of papers aa of the paper bundle are floated and separated from the paper bundle. Paper conveyance unit 144 holds, by suction, an uppermost sheet of paper aa among the floated sheets of paper aa, and then, conveys this uppermost sheet of paper aa held by suction to conveyance unit 16.

Air blowing unit 18 blows air to the paper bundle for the purpose of causing sheets of paper aa to be floated and separated from the paper bundle such that paper conveyance unit 144 can hold sheet of paper aa well by suction. It is to be noted that paper storage 141 can generally store sheets of paper having different pieces of information such as different lengths, different thicknesses, and different types. When air blowing unit 18 cannot change the air blowing position, floating and separation of sheets of paper aa may be insufficient.

In the present example, the air blowing position of air blowing unit 18 can be changed in first direction x. The air blowing position of air blowing unit 18 is adjusted in accordance with sheets of paper of different types, and thereby, sheets of paper aa can be more appropriately floated and separated from the paper bundle. The air blowing position means the position at which air blown from air blowing unit 18 is separated from air blowing unit 18 in second direction y (that is, the position at which air blowing unit 18 blows air in second direction y).

The air blowing position of air blowing unit 18 is changed specifically by the following two methods.

Firstly, the air blowing position can be changed by moving air blowing unit 18 in first direction x.

Secondly, air blowing unit 18 is provided with a plurality of air outlets arranged to extend in first direction x. Thus, the air blowing position is changed by switching of these air outlets.

In the following, the first method of changing the air blowing position will be specifically described.

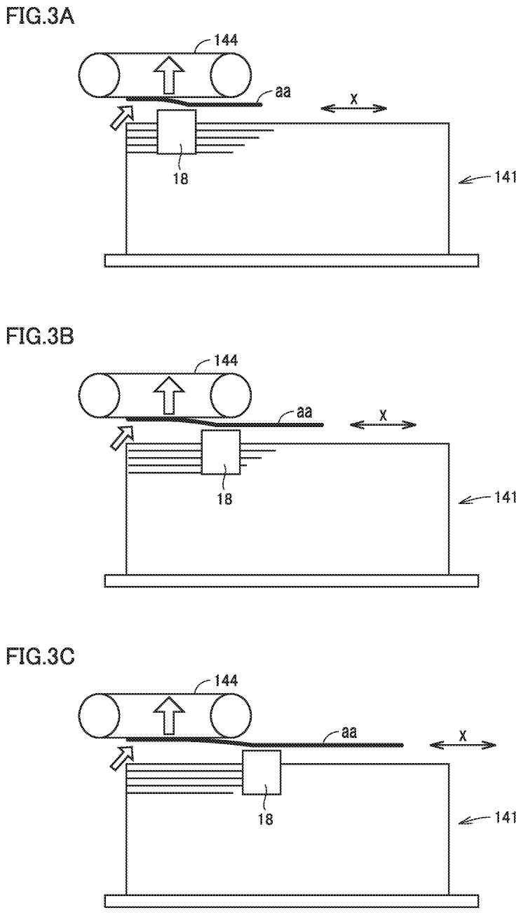

Referring to FIGS. 3A to 3C, paper storage 141 shown in FIG. 3A contains sheets of paper each having a relatively shorter length, which is A5 paper, for example; paper storage 141 shown in FIG. 3B contains sheets of paper each having a relatively longer length, which is A4 paper, for example; and paper storage 141 shown in FIG. 3C contains sheets of paper each having a much longer length, which is A3 paper, for example

As apparent from FIGS. 3A to 3C, irrespective of the length of each sheet of paper aa, the front ends of sheets of paper aa are aligned at the inner end surface (the left end surface in FIG. 3A) of paper storage 141 in first direction x. When sheet of paper aa is A5 paper, as shown in FIG. 3A, the center of each sheet of paper aa in first direction x is located close to the inner end surface of paper storage 141. When sheet of paper aa is A4 paper, as shown in FIG. 3B, the center of each sheet of paper aa in first direction x is located more distant from the inner end surface of paper storage 141 than the case where sheet of paper aa is A5 paper. When sheet of paper aa is A3 paper, as shown in FIG. 3C, the center of each sheet of paper aa in first direction x is located much more distant from the inner end surface of paper storage 141 than the case where sheet of paper aa is A4 paper.

Furthermore, in order to cause sheets of paper aa to be more sufficiently floated and separated from the paper bundle, air blowing unit 18 is located slightly forward of the center of each sheet of paper aa in first direction x (located to close to the center position of each sheet of paper aa in first direction x). In this case, when the air blowing position is in the vicinity of the center position of each sheet of paper aa, the entire sheets of paper aa can be floated and separated from the paper bundle during air blowing. This can avoid the problem that the rearward portion of each sheet of paper aa float insufficiently during air blowing due to the air blowing position located in the forward portion of each sheet of paper aa, and also can avoid the problem that the forward portion of each sheet of paper aa floats insufficiently during air blowing due to the air blowing position located in the rearward portion of each sheet of paper aa.

As to air blowing units 18 of different types (for example, an air blowing method or an air blowing direction), the relative optimum position between air blowing unit 18 and each sheet of paper aa is not fixed, but needs to be specifically adjusted in accordance with specific conditions. The feature that air blowing unit 18 is disposed forward of the center of each sheet of paper aa in first direction x is merely one specific embodiment of the present disclosure.

Since air blowing unit 18 is movable in first direction x, the position of air blowing unit 18 can be adjusted in first direction x in a significantly wide range. For a plurality of different types of sheets of paper including A5 paper, A4 paper and A3 paper as mentioned above, air blowing unit 18 is adjusted to be located at a theoretically optimum position to thereby allow an optimum degree of floating and separation of the sheets of paper. Thus, paper feed mechanism 14 has wider applicability to some extent. Furthermore, the system in which air blowing unit 18 moves in first direction x is achieved in a simple configuration, thereby allowing lower cost.

In other words, not only a simple configuration and lower cost are achieved, but also the air blowing position of the air blowing unit can be adjusted to any position in the first direction, i.e., the air blowing position can be adjusted in the first direction in a relatively wide range, thereby allowing excellent applicability.

Specifically, in the example shown in FIG. 3A, since each sheet of paper aa has a short length, the center of each sheet of paper aa in first direction x is located close to the inner end surface of paper storage 141, and air blowing unit 18 in this case is also located relatively close to the inner end surface of paper storage 141.

In contrast, in the example shown in FIG. 3B, each sheet of paper aa is larger than that in the example shown in FIG. 3A. Accordingly, the center of each sheet of paper aa in first direction x is located more distant from the inner end surface of paper storage 141, and air blowing unit 18 in this case is also located more distant from the inner end surface of paper storage 141.

Furthermore, in the example shown in FIG. 3C, each sheet of paper aa is much larger than that in the example shown in FIG. 3B. Accordingly, the center of each sheet of paper aa in first direction x is located much more distant from the inner end surface of paper storage 141, and air blowing unit 18 in this case is also located much more distant from the inner end surface of paper storage 141. Thereby, air blowing unit 18 can change its air blowing position in first direction x in accordance with the length of each sheet of paper aa in paper storage 141.

Paper storage 141 can contain different types of sheets of paper aa. In this case, different types of sheets of paper aa are different in size (length and the like). It is to be noted that the size of each sheet of paper remains the same after the type of sheet of paper aa is set. For example, each of A3 paper, A4 paper, A5 paper, B3 paper and the like has a fixed uniform size. After the type of each sheet of paper in paper storage 141 is set, the air blowing position of air blowing unit 18 in first direction x can also be set according to the type.

Accordingly, in order to adjust air blowing unit 18 at each of defined positions in accordance with different types of sheets of paper aa, a plurality of defined positions corresponding to respective types of sheets of paper aa can be set in advance in paper storage 141 in first direction x.

The air blowing position of air blowing unit 18 may be changed in a manual control scheme. For example, two slide rails (not shown) extending in first direction x are installed in paper feed mechanism 14. Two air blowing units 18 located to face each other are disposed on the respective slide rails so as to be slidable. When the type of each sheet of paper in paper storage 141 is changed, acting force is applied to air blowing unit 18, and simultaneously, the air blowing positions of two air blowing units 18 in first direction x are changed. This allows air blowing unit 18 to more sufficiently float sheets of paper aa to be separated from each other in the process of blowing air to sheets of paper aa.

By the manual control scheme, the position of air blowing unit 18 can be finely adjusted based on the actual operation state of image forming apparatus 1 to thereby fix the actual optimum position of air blowing unit 18 (theoretically, the optimum air blowing position can be generally calculated but the calculated air blowing position is not necessarily an actual optimum position). Thereby, the technical effect of floating and separating sheets of paper aa in paper storage 141 can be more excellently achieved.

The specific air blowing position of air blowing unit 18 significantly influences floating and separation of sheets of paper aa, and additionally, the air blowing amount of air blowing unit 18 also significantly influences floating and separation of sheets of paper aa. In the case where the basis weight of each sheet of paper aa is relatively large due to the type and the thickness of each sheet of paper aa (the basis weight of a sheet of paper represents a magnitude of the mass of a sheet of paper per unit area, and the explanation in this case shows a relatively large mass per unit area), a larger air blowing amount is required for allowing each sheet of paper aa to be completely floated and separated from the paper bundle. In the case where the basis weight of each sheet of paper aa is relatively small due to the type and the thickness of each sheet of paper aa (that is, the mass of a sheet of paper per unit area is small), a relatively small air blowing amount is required to an extent enough to allow sheets of paper aa to be floated and separated from each other, but sheets of paper aa are not blown away by excessive force of air. In this case, the air blowing amount of air blowing unit 18 may be adjusted manually in accordance with the type and the thickness of each sheet of paper aa.

The air blowing position of air blowing unit 18 may be changed in an automatic control scheme. For example, paper feed mechanism 14 may be equipped with a detection unit (not shown). This detection unit is used for detecting the information about sheets of paper aa stored in paper storage 141. Also, controller 17 as a control unit can automatically change the air blowing position of air blowing unit 18 according to the detection result detected by the detection unit.

Accordingly, when sheets of paper aa are placed in paper storage 141, the detection unit and the control unit cooperate to automatically detect the information about the sheets of paper, and thereby can adjust the air blowing position of air blowing unit 18 based on the detected information. Since position adjustment of air blowing unit 18 can be automatically done, not only errors caused by manual adjustment can be reduced, but also time savings and efficiency improvement can be achieved.

The information about the sheets of paper in paper storage 141 not only can be detected by the detection unit, but also may be input directly by a user. In this case, controller 17 changes the air blowing position and the air blowing amount of air blowing unit 18 based on the information about the sheets of paper that has been input by the user.

As described above, the air blowing amount of air blowing unit 18 also significantly influences floating and separation of sheets of paper aa. Thus, the detection unit can specifically detect the length, the thickness and the type of each sheet of paper during detection of the information about sheets of paper aa. The optimum air blowing position of air blowing unit 18 is set according to the detected length of each sheet of paper. Then, the optimum air blowing amount of air blowing unit 18 is set according to the detected thickness and type of each sheet of paper (by which the basis weight of a sheet of paper can be calculated). Thereby, sheets of paper aa in paper storage 141 are more sufficiently floated and separated from the paper bundle.

In the present example, air blowing unit 18 is installed in a slide rail to allow air blowing unit 18 to slide along the slide rail, thereby changing the position of air blowing unit 18 in first direction x. Specifically, a gear set (not shown) may be installed in one of the slide rail and air blowing unit 18 while a rack (not shown) operating in cooperation with the gear set may be installed in the other one of the slide rail and air blowing unit 18 (the rack may be specifically integrated with air blowing unit 18 or integrated with the slide rail). The gear set and the rack operate in cooperation with each other to thereby move air blowing unit 18 in first direction x. Rotational movement of the gear set may be controlled by a driving motor (which corresponds to an automatic control scheme). Alternatively, the gear set may be rotationally moved by applying acting force to air blowing unit 18 (which corresponds to a manual control scheme).

The gear set allows air blowing unit 18 to move stably along the slide rail. In other words, as the slide rail and the gear set operate in cooperation with each other, the movement stability of air blowing unit 18 can be improved. Thus, the air blowing position of air blowing unit 18 can be adjusted accurately and efficiently.

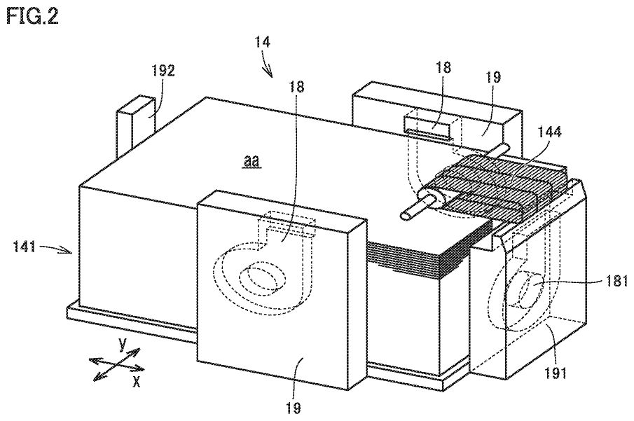

Also, as shown in FIG. 2, in the present example, paper feed mechanism 14 further includes a separation air blowing unit 181 for blowing air to sheets of paper aa. Separation air blowing unit 181 is located at the front ends of sheets of paper aa so as to extend in first direction x.

When two air blowing units 18 located on both sides of sheets of paper aa in second direction y blow air to sheets of paper aa, some of upper sheets of paper aa of the paper bundle are floated and separated from the paper bundle by disturbance of air flow. However, paper conveyance unit 144 only has to hold one uppermost sheet of paper aa by suction and convey this one uppermost sheet of paper aa. Nevertheless, when some of upper sheets of paper aa among floated sheets of paper aa are in close contact with each other or only slightly spaced apart from each other, paper conveyance unit 144 may convey a plurality of sheets of paper aa to conveyance unit 16, to thereby cause a paper jam and the like, which may influence the normal operation of image forming apparatus 1.

By disposing separation air blowing unit 181 at the front ends of sheets of paper aa, separation air blowing unit 181 blows air to sheets of paper aa. Thus, when paper conveyance unit 144 holds, by suction, an uppermost sheet of paper aa among the floated sheets of paper aa, separation air blowing unit 181 blows air to allow remaining floated sheets of paper aa to be separated from uppermost sheet of paper aa. Thus, uppermost sheet of paper aa is brought into close contact with paper conveyance unit 144 by the action of separation air blowing unit 181, whereas remaining floated sheets of paper aa fall onto the paper bundle by the action of separation air blowing unit 181. Thereby, paper conveyance unit 144 can be prevented from conveying a plurality of sheets of paper aa to conveyance unit 16, and therefore, a paper jam can be avoided, with the result that no influence is exerted upon the normal operation of image forming apparatus 1.

FIGS. 2 and 3 each show the case where only one pair of air blowing units are provided in paper feed mechanism 14. In the case where sheets of paper aa in paper storage 141 are considerably long, a problem of insufficient floating and separation of the sheets of paper still may occur even if only one pair of air blowing units is provided such that two air blowing units located to face each other are disposed at appropriate positions.

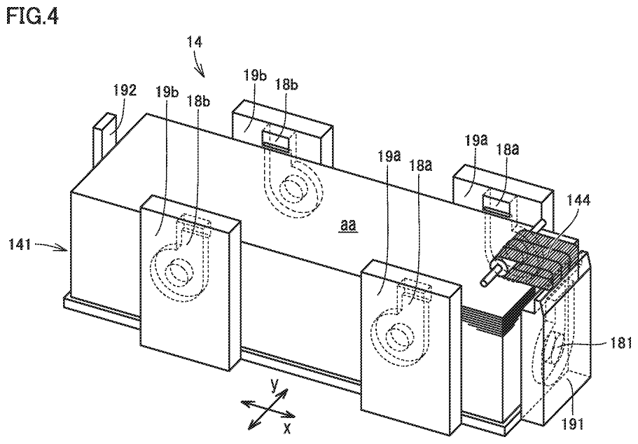

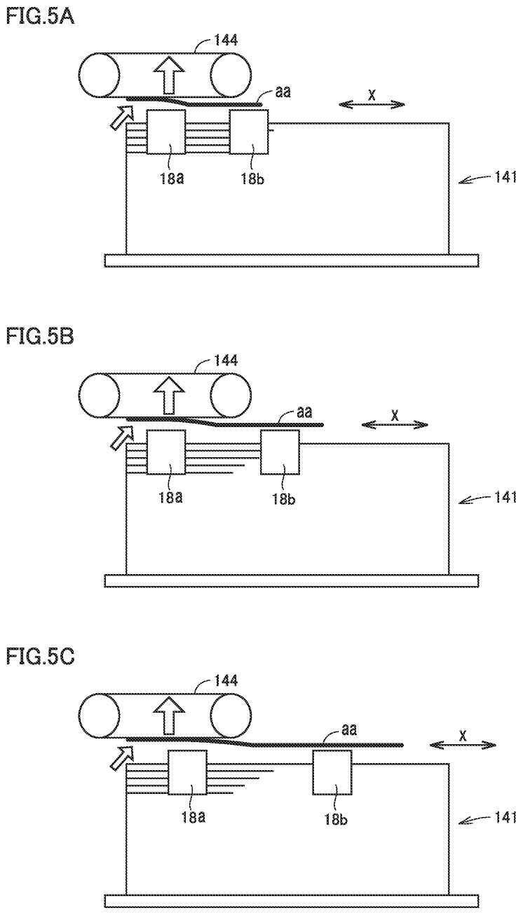

In contrast, referring to FIGS. 4 and 5, paper feed mechanism 14 can include two pairs of air blowing units including: two first air blowing units 18a disposed to face each other; and two second air blowing units 18b disposed to face each other. First air blowing unit 18a and second air blowing unit 18b are arranged sequentially to extend in first direction x. First air blowing unit 18a is located relatively close to the front ends of sheets of paper aa while second air blowing unit 18b is located relatively away from the front ends of sheets of paper aa. Two pairs of air blowing units are provided to thereby allow air to be relatively uniformly blown to sheets of paper aa in first direction x Furthermore, sheets of paper aa are more sufficiently floated and separated from each other, thereby reducing the resistance against paper conveyance.

Specifically, first air blowing unit 18a and second air blowing unit 18b may be installed in the following manner.

Firstly, first air blowing unit 18a is fixed while second air blowing unit 18b is moved in first direction x to change the air blowing position.

Secondly, second air blowing unit 18b is fixed while first air blowing unit 18a is moved in first direction x to change the air blowing position.

Thirdly, both first air blowing unit 18a and second air blowing unit 18b are moved in first direction x to change their respective air blowing positions.

Referring to FIGS. 5A to 5C, paper storage 141 shown in FIG. 5A contains sheets of paper each having a relatively short length, which is A5 paper, for example In this case, first air blowing unit 18a and second air blowing unit 18b are located close to the respective ends on both sides of sheets of paper aa in first direction x.

Paper storage 141 shown in FIG. 5B contains sheets of paper each having a slightly longer length, which is A4 paper, for example. In this case, first air blowing unit 18a and second air blowing unit 18b are located close to the respective ends on both sides of sheets of paper aa in first direction x. The distance between first air blowing unit 18a and second air blowing unit 18b is larger than that in the example in FIG. 5A.

Paper storage 141 shown in FIG. 5C contains sheets of paper each having a much longer length, which is A3 paper, for example. In this case, first air blowing unit 18a and second air blowing unit 18b are located close to the respective ends on both sides of sheets of paper aa in first direction x. The distance between first air blowing unit 18a and second air blowing unit 18b is much larger than that in the example in FIG. 5B.

The above-described examples show that the positions of two pairs of air blowing units in first direction x are controlled to allow adaptation to sheets of paper aa having different lengths, and allow more sufficient floating and separation of sheets of paper aa having different lengths, thereby reducing the resistance against paper conveyance.

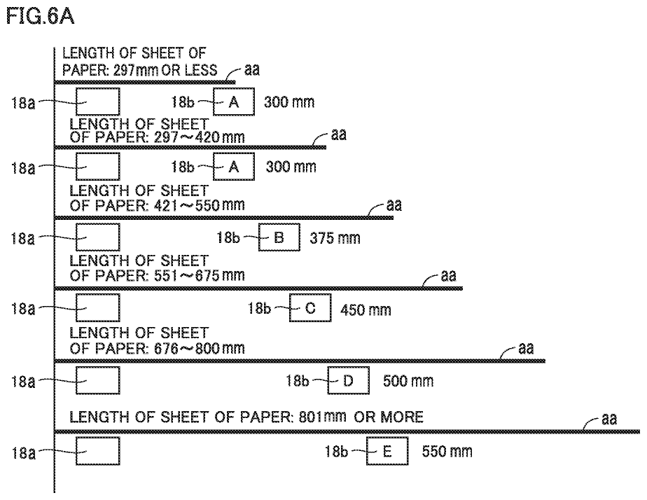

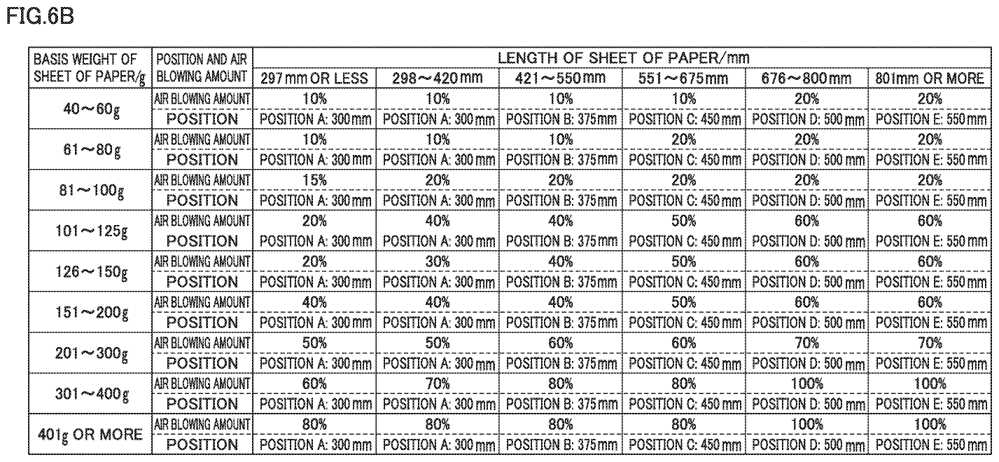

FIG. 6A shows the relation between different lengths of the sheets of paper and the air blowing positions of the air blowing units. FIG. 6B shows the relation among different lengths of the sheets of paper, different basis weights of the sheets of paper, and the air blowing positions and the air blowing amounts of the air blowing unit. In this case, paper feed mechanism 14 includes two pairs of air blowing units. Each first air blowing unit 18a is located relatively close to the inner end surface of paper storage 141 (close to the front ends of sheets of paper aa) and fixed in first direction x. Each second air blowing unit 18b is located relatively away from the inner end surface of paper storage 141 (away from the front ends of sheets of paper aa), and can be moved in first direction x to change the air blowing position.

In the present example, the air blowing port of first air blowing unit 18a only has to be located relatively close to the inner end surface of paper storage 141 (close to the front ends of sheets of paper aa), but the distance from the inner end surface of paper storage 141 to this air blowing port is not particularly limited.

As to second air blowing unit 18b, based on experiments, the air blowing position of second air blowing unit 18b can be set as follows such that sheets of paper aa having different lengths can be more sufficiently floated and separated from the paper bundle.

In the first case, when each sheet of paper aa has a length of 297 mm or less (for example, each sheet of paper is equal in size to A4 paper or smaller than A4 paper), second air blowing unit 18b is controlled to move in first direction x such that second air blowing unit 18b is located at a position A. In this case, the distance between the air blowing port of second air blowing unit 18b and the inner end surface of paper storage 141 is preferably 300 mm.

In the second case, when each sheet of paper aa has a length of 298 mm to 420 mm (for example, each sheet of paper is equal in size to A3 paper or smaller than A3 paper but larger than A4 paper), second air blowing unit 18b is controlled to move in first direction x such that second air blowing unit 18b is located at position A. In this case, the distance between the air blowing port of second air blowing unit 18b and the inner end surface of paper storage 141 is similarly 300 mm.

In the third case, when each sheet of paper aa has a length of 421 mm to 550 mm (for example, B3 paper or C3 paper), second air blowing unit 18b is controlled to move in first direction x such that second air blowing unit 18b is located at a position B. In this case, the distance between the air blowing port of second air blowing unit 18b and the inner end surface of paper storage 141 is preferably 375 mm.

In the fourth case, when each sheet of paper aa has a length of 551 mm to 675 mm (for example, A2 paper or C2 paper), second air blowing unit 18b is controlled to move in first direction x such that second air blowing unit 18b is located at a position C. In this case, the distance between the air blowing port of second air blowing unit 18b and the inner end surface of paper storage 141 is preferably 450 mm.

In the fifth case, when each sheet of paper aa has a length of 676 mm to 800 mm (for example, B2 paper), second air blowing unit 18b is controlled to move in first direction x such that second air blowing unit 18b is located at a position D. In this case, the distance between the air blowing port of second air blowing unit 18b and the inner end surface of paper storage 141 is preferably 500 mm.

In the sixth case, when each sheet of paper aa has a length of 801 mm or more (for example, A1 paper, B1 paper or C1 paper), second air blowing unit 18b is controlled to move in first direction x such that second air blowing unit 18b is located at a position E. In this case, the distance between the air blowing port of second air blowing unit 18b and the inner end surface of paper storage 141 is preferably 550 mm.

Furthermore, the air blowing amount needs to be adjusted in accordance with the length, the thickness and the type of each sheet of paper aa so as to cause each sheet of paper aa to be more sufficiently floated and separated from the paper bundle. In this case, the air blowing amount means the amount of gas that passes through the air blowing port per unit time. In general, as the basis weight of a sheet of paper is larger in accordance with the type and the thickness of each sheet of paper, the air blowing amount is larger. As the length of a sheet of paper is longer, the air blowing amount is larger.

When the basis weight of each sheet of paper is 301 g or more and the length of each sheet of paper is 676 mm or more, the air blowing amount of second air blowing unit 18b attains a maximum value (a rated maximum air amount of second air blowing unit 18b). In this case, the air blowing amount of first air blowing unit 18a also attains a maximum value. As the basis weight of each sheet of paper is smaller or the length of each sheet of paper is shorter, the air blowing amount of second air blowing unit 18b is smaller accordingly. For example, when each sheet of paper has a basis weight of 101 g to 125 g and has a length of 421 mm to 550 mm, the air blowing amount of second air blowing unit 18b is 40% of the rated maximum air amount. In this case, the air blowing amount of first air blowing unit 18a may be changed to 40% of the rated maximum air amount of first air blowing unit 18a. FIG. 6B specifically shows the relation among the air blowing amount of second air blowing unit 18b, the basis weight of each sheet of paper, and the length of each sheet of paper.

Paper feed mechanism 14 may include two pairs of air blowing units that extend in first direction x, or may include three or more pairs of air blowing units that extend in first direction x. In general, as the number of pairs of air blowing units extending in first direction x is larger, the sheets of paper are more effectively floated and separated from each other, but the configuration of paper feed mechanism 14 becomes more complicated and the cost becomes higher. It is preferable to provide a larger number of pairs of air blowing units as the length of each sheet of paper is longer. Thereby, the technical effect of floating and separation of each sheet of paper is improved.

Referring to FIG. 2, paper feed mechanism 14 further includes one pair of lateral-side regulation units. One pair of lateral-side regulation units is disposed such that two lateral-side regulation units 19 are located to face each other in second direction y and positioned on respective ones of both sides of sheets of paper aa. Air blowing units 18 of the present disclosure are not necessarily independently disposed, but may be disposed in respective ones of two lateral-side regulation units 19 as shown in FIG. 2.

Similarly, referring to FIG. 4, paper feed mechanism 14 further includes two pairs of lateral-side regulation units including: two first lateral-side regulation units 19a located to face each other; and two second lateral-side regulation units 19b located to face each other. First lateral-side regulation unit 19a and second lateral-side regulation unit 19b are arranged sequentially to extend in first direction x. Two first air blowing units 18a located to face each other may be disposed in respective ones of two first lateral-side regulation units 19a on both sides. Two second air blowing units 18b located to face each other may be disposed in respective ones of two second lateral-side regulation units 19b on both sides.

The functions of lateral-side regulation unit 19, first lateral-side regulation unit 19a, and second lateral-side regulation unit 19b are to regulate sheets of paper aa in paper storage 141 along second direction y to properly position sheets of paper aa such that the front ends of sheets of paper aa extend in parallel with the inlet port of the conveyance unit, thereby avoiding inclination of sheets of paper aa so as to improve the fixing quality. In accordance with the width of each sheet of paper, two lateral-side regulation units 19 located to face each other, two first lateral-side regulation units 19a located to face each other, and two second lateral-side regulation units 19b located to face each other can adjust the distances between their respective two regulation units located to face each other in second direction y, thereby regulating the sheets of paper having different widths so to be adapted to the sheets of paper having different widths.

Air blowing unit 18, first air blowing unit 18a, and second air blowing unit 18b are disposed in lateral-side regulation unit 19, first lateral-side regulation unit 19a, and second lateral-side regulation unit 19b, respectively, of image forming apparatus 1 itself, thereby allowing the entire configuration to be simplified so as to enhance the space utilization ratio. Furthermore, movements of lateral-side regulation unit 19, first lateral-side regulation unit 19a and second lateral-side regulation unit 19b in first direction x are relatively readily adjusted. Thus, by providing air blowing unit 18, first air blowing unit 18a and second air blowing unit 18b in lateral-side regulation unit 19, first lateral-side regulation unit 19a and second lateral-side regulation unit 19b, respectively, the air blowing positions are readily and simply changed.

Continuously referring to FIGS. 2 and 4, paper feed mechanism 14 further includes a front-side regulation unit 191 disposed on the front side of paper storage 141. Front-side regulation unit 191 is normally fixed and used for regulating the front ends of sheets of paper aa such that the front ends of sheets of paper aa are located along the inner end surface of paper storage 141 in first direction x. Separation air blowing unit 181 is disposed in front-side regulation unit 191, so that paper feed mechanism 14 is reduced in size. Paper feed mechanism 14 further includes a back-side regulation unit 192. Back-side regulation unit 192 is disposed to face front-side regulation unit 191 in first direction x and can adjust the distance between this back-side regulation unit 192 and front-side regulation unit 191 in accordance with the length of each sheet of paper aa. Front-side regulation unit 191, back-side regulation unit 192, and lateral-side regulation units 19, 19a, and 19b each are disposed around sheets of paper aa so as to restrict the specific positions of sheets of paper aa in paper storage 141 (i.e., the front ends of the sheets of paper extend in parallel with the inlet port of the conveyance unit, and the center of each sheet of paper in the second direction coincides with the center of the paper conveyance unit and the center of the conveyance unit).

As described above, the air blowing position of the air blowing unit is changed by two methods. The following is an explanation about the second method for changing the air blowing position.

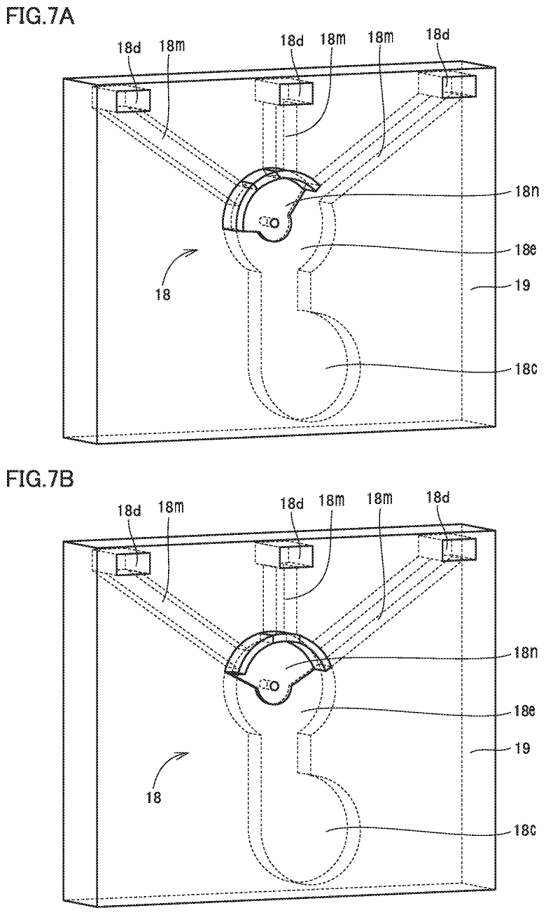

Referring to FIGS. 7A and 7B, the configuration of air blowing unit 18 of the present disclosure will be specifically described. The configurations of first air blowing unit 18a and second air blowing unit 18b can refer to the above-mentioned air blowing unit 18.

Air blowing unit 18 includes: an air blowing source 18c (for example, a fan); an air outlet 18d that opens toward the paper bundle in paper storage 141; and an air flow path 18m that connects an air blowing port 18e of air blowing source 18c and air outlet 18d. In this case, a plurality of air outlets 18d are disposed so as to extend side by side in first direction x. A plurality of air flow paths 18m are disposed to correspond to respective air outlets 18d so as to allow air blowing ports 18e to communicate with respective air outlets 18d. Air blowing source 18c generates air as an air source. Gas flows from air blowing port 18e through each air flow path 18m into each air outlet 18d, from which gas is eventually emitted so as to blow air to the paper bundle in paper storage 141, to thereby float and separate some of upper sheets of paper aa of the paper bundle.

In this case, air blowing unit 18 in FIGS. 7A and 7B specifically includes three air outlets 18d and three air flow paths 18m. Three air outlets 18d are disposed to correspond to respective three air flow paths 18m in a one-to-one relation.

In the present example, air blowing unit 18 further includes a blowing-air switching unit 18n that can switch air flow path 18m to be opened and closed. Thus, blowing-air switching unit 18n is controlled to thereby allow selection from among different air flow paths 18m to be opened and closed, and also thereby allow selection from among different air outlets 18d. By switching among different air outlets 18d to emit gas, the air blowing position of air blowing unit 18 in first direction x is changed so as to adapt air blowing unit 18 to any of different types of sheets of paper. Thereby, all different types of sheets of paper can be completely floated and separated from each other.

Blowing-air switching unit 18n is disposed, for example, at the position of air blowing port 18e. The rotation of blowing-air switching unit 18n is controlled to switch a pair of air flow path 18m and air outlet 18d to another pair of air flow path 18m and air outlet 18d. As shown in FIG. 7A, blowing-air switching unit 18n rotates counterclockwise to the first position. In this case, left-side air flow path 18m and center air flow path 18m are closed while right-side air flow path 18m is opened. Thus, gas is emitted from right-side air outlet 18d through right-side air flow path 18m.

As shown in FIG. 7B, blowing-air switching unit 18n rotates to the intermediate position. In this case, left-side air flow path 18m, right-side air flow path 18m and center air flow path 18m each are closed, so that gas is not emitted.

Blowing-air switching unit 18n may rotate clockwise to another position such that one or more of left-side air flow path 18m, center air flow path 18m and right-side air flow path 18m are selectively opened. Also, the specific configuration of blowing-air switching unit 18n is not limited to the above, and one or more of left-side air flow path 18m, center air flow path 18m and right-side air flow path 18m may be selectively opened.

Thus, the entire position of air blowing unit 18 does not need to be changed as compared with the first embodiment in which a plurality of air outlets 18d are set in advance according to the information about the sheets of paper often used, one or more air outlets 18d are selected for the sheets of paper having different pieces of information to change the air blowing position and thus the air blowing position is changed. Accordingly, not only a simple configuration and low cost are achieved, but also a simple operation and high reliability are achieved since the positions of air outlets 18d are set in advance.

The above-mentioned two methods of changing the air blowing position may be separately employed or may be employed in combination, in each of which no influence is exerted upon implementation of the technological solution.

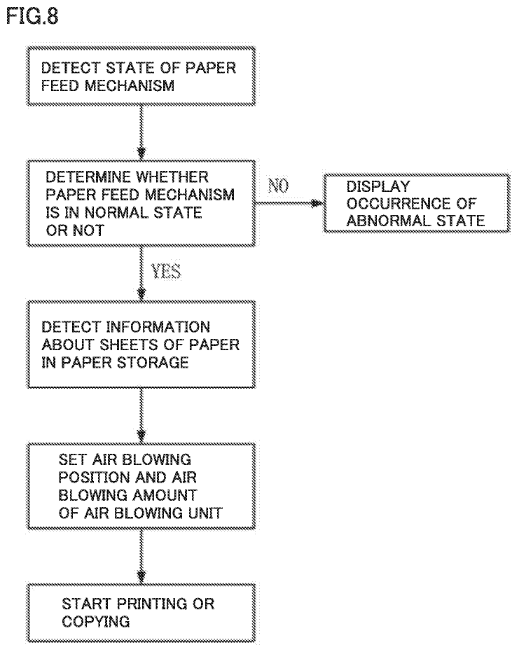

In the following, a specific operation state of the paper feed mechanism of the present disclosure will be described with reference to FIG. 8.

Sheets of paper aa stacked in a paper bundle are stored in paper storage 141. The positions of lateral-side regulation unit 19 and back-side regulation unit 192 are adjusted according to the widths and the lengths of sheets of paper aa.

The state of paper feed mechanism 14 is detected, i.e., self-check for paper feed mechanism 14 is performed before image forming apparatus 1 operates, to thereby detect whether each index of paper feed mechanism 14 is normal or not. For example, it can be detected whether paper storage 141 of paper feed mechanism 14 is in a locked state or not. For example, when paper storage 141 is in an unlocked state, a notification of an abnormal state is displayed, so that a print or copy program cannot be performed. When paper storage 141 is in a locked state, a notification of a normal state is displayed, so that a print or copy program can be performed.

When it is determined that paper feed mechanism 14 is in a normal state, the information about the sheets of paper in paper storage 141 can be detected using a detection unit (not shown) disposed in paper feed mechanism 14. The information about the sheets of paper can specifically include the length, the thickness and the type of each sheet of paper.

The air blowing position of air blowing unit 18 in first direction x is set according to the detected length of each sheet of paper. Controller 17 controls the switching operation of blowing-air switching unit 18n, or controls air blowing unit 18 to move in first direction x, or employs the combination of these controls, and thereby can change the air blowing position in first direction x. Furthermore, the air blowing amount of air blowing unit 18 is set according to the detected thickness and type of each sheet of paper.

The information about the sheets of paper in paper storage 141 not only can be detected by the detection unit but also can be input directly by a user. In this case, controller 17 changes the air blowing position and the air blowing amount of air blowing unit 18 according to the information about the sheets of paper input by the user.

When printing or copying is started, air blowing unit 18 located at the set position blows a set blowing amount of air to paper storage 141 to cause some of upper sheets of paper aa of the paper bundle in paper storage 141 to be sufficiently floated and separated from each other. Then, paper conveyance unit 144 holds, by suction, an uppermost sheet of paper among the floated sheets of papers aa and then conveys the uppermost sheet of paper in the floated state to conveyance unit 16.

Then, conveyance unit 16 conveys the sheet of paper to fixing mechanism 23, and fixing mechanism 23 fixes a toner image onto the sheet of paper, and thereby implements a print or copy operation.

The above description will be summarized as follows.

The present embodiment provides a paper feed mechanism and an image forming apparatus, by which an air blowing position of an air blowing unit can be adjusted based on information about different types of sheets of paper stored in a paper storage.

A paper feed mechanism according to the present embodiment includes: a paper storage to store sheets of paper; an air blowing unit disposed on each of both sides of the paper storage in a second direction orthogonal to a first direction corresponding to a paper conveyance direction, in which the air blowing unit blows air to a side end of each of the sheets of paper in the paper storage to float one or some of the sheets of paper in the paper storage; and a paper conveyance unit disposed above the paper storage, in which the paper conveyance unit holds, by suction, an uppermost sheet of paper among the floated sheets of paper, and conveys the uppermost sheet of paper. An air blowing position of the air blowing unit is changeable in the first direction according to information about the sheets of paper.

Thereby, the air blowing position of the air blowing unit can be adjusted in the first direction. Thus, the air blowing position can be adjusted as required to an appropriate position at which the entire sheets of paper can be completely floated and separated from each other. This can avoid the problem that local floating of the sheets of paper is insufficient in the air blowing process. For example, the air blowing position of the air blowing unit can be adjusted in the first direction according to the sheets of paper having different pieces of information (different types, different lengths, and different thicknesses) so as to set the air blowing position close to the center position of each sheet of paper in the first direction. In the air blowing process, the air blowing unit can blow air toward the center position of each sheet of paper so as to allow floating of the entire sheets of paper. This can avoid the problem that the rearward portions of the sheets of paper float insufficiently in the air blowing process due to the air blowing position located in the forward portions of the sheets of paper. Also, the problem can be avoid that the forward portions of the sheets of paper float insufficiently in the air blowing process due to the air blowing position located in the rearward portions of the sheets of paper.

Preferably, a lateral-side regulation unit for regulating sheets of paper is provided on each of both sides of the paper storage, the air blowing unit is located in the lateral-side regulation unit, and the lateral-side regulation unit is movable in the first direction.

The air blowing unit is disposed in the lateral-side regulation unit of the image forming apparatus itself, so that the entire configuration can be simplified, and the space utilization ratio can be improved. Furthermore, the movement of the lateral-side regulation unit in the first direction is relatively readily adjusted. Also, the air blowing unit is disposed in the lateral-side regulation unit, so that the air blowing position can be more readily and simply changed. Furthermore, the lateral-side regulation unit is moved in the second direction and thereby can regulate the sheets of paper having different widths in the paper storage. Thereby, the sheets of paper are properly positioned such that the front ends of the sheets of paper extend in parallel with the inlet port of the conveyance unit, thereby avoiding inclination of the sheets of paper to improve the fixing quality.

Furthermore, a plurality of the air blowing units are provided. Each of the air blowing units includes: an air blowing source; a plurality of air outlets disposed side by side in the first direction; a plurality of air flow paths that each connect a corresponding one of the air outlets to an air blowing port of the air blowing source; and a blowing-air switching unit that switches each of the air flow paths to be opened and closed.

Based on the information about the sheets of paper often used, a plurality of air outlets are disposed in advance, and one or more air outlets are selected for the sheets of paper having different pieces of information to change the air blowing position. Thus, not only a simple configuration and low cost are achieved, but also a simple operation and high reliability are achieved since the positions of the plurality of air outlets are set in advance.

Furthermore, the paper feed mechanism further includes a detection unit. The detection unit detects information about sheets of paper stored in the paper storage. A control unit in cooperation with the detection unit may adjust at least one of the air blowing position and an air blowing amount according to a detection result of the detection unit.

When sheets of paper are placed in the paper storage, the detection unit automatically detects the information about the sheets of paper, and the control unit adjusts the air blowing position and/or the air blowing amount of the air blowing unit according to the detection result of the detection unit. Since position adjustment of the air blowing unit can be automatically done, not only errors caused by manual adjustment can be reduced, but also time savings and efficiency improvement can be achieved.

In one embodiment, the information about the sheets of paper includes at least one of a length, a thickness and a type of each sheet of paper.

The information about the sheets of paper detected by the detection unit may specifically include the detected length, the detected thickness and the detected type of each sheet of paper. The length of each sheet of paper allows determination of the air blowing position of the air blowing unit in the first direction. The thickness and the type of each sheet of paper allows determination of the air blowing amount of the air blowing unit. The relation between the length of each sheet of paper and the position of the air blowing unit is preferably defined such that the air blowing position is located close to the center position of each sheet of paper in the first direction, as described above. The relation among the type of each sheet of paper, the thickness of each sheet of paper and the air blowing amount is preferably defined as follows. When the basis weight of each sheet of paper is relatively large due to the type and the thickness of each sheet of paper (i.e., the mass of a sheet of paper per unit area is relatively large), the air blowing unit can be adjusted to achieve a larger air blowing amount so as to allow the sheets of paper to be completely floated and separated from each other. When the basis weight of each sheet of paper is relatively small due to the type and the thickness of each sheet of paper (i.e., the mass of a sheet of paper per unit area is relatively small), the air blowing unit can be adjusted to achieve a smaller air blowing amount so as to prevent the sheets of paper from being blown away by excessive force of air on the condition that the sheets of paper can still be floated and separated from each other

In one embodiment, a user is able to manually adjust the air blowing position.

According to the method for manual control, the position of the air blowing unit can be finely adjusted based on the actual operation state of the image forming apparatus to thereby set an actual optimum air blowing position of the air blowing unit (a theoretically optimum air blowing position can be generally calculated, which is however not necessarily an actual optimum position). Thereby, the technical effect of causing the sheets of paper in the paper storage to be floated and separated from each other can be more excellently achieved.

For the sheets of paper having different thicknesses and different types, the air blowing amount of the air blowing unit can be manually adjusted. Thereby, the sheets of paper can be prevented from being blown away by excessive force of air on the condition that the sheets of paper can still be floated and separated from each other.

In one embodiment, a plurality of pairs of the air blowing units are provided to extend in the first direction, and air blowing positions of at least one pair of the air blowing units are changeable in the first direction.

The sheets of paper having considerably long lengths may cause a problem of insufficient floating and separation of the sheets of paper even if only one pair of air blowing units is presumed to be provided such that the paired air blowing units are disposed at more appropriate positions. Two or more pairs of air blowing units are provided, and thereby, air can be relatively uniformly blown to the sheets of paper in the first direction, with the result that the sheets of paper can be more completely floated and separated from each other.

Two pairs of the air blowing units are provided to extend in the first direction, and a position of the air blowing unit located downstream in the paper conveyance direction may be changeable.

Two pairs of air blowing units are provided. Among the two pairs of air blowing units, one pair of air blowing units can be changed in position. Thereby, even on the precondition that longer-length sheets of paper are more sufficiently floated and separated from each other, neither the configuration of the paper feed mechanism nor the method of controlling the air blowing unit becomes relatively complicated.

In one embodiment, the air blowing unit is moved in the first direction by a slide rail and a gear set.

Thereby, the air blowing unit can be stably moved along the slide rail by the gear set. In other words, the movement stability of the air blowing unit can be improved by adopting the cooperative operation between the slide rail and the gear set. In this way, the air blowing position of the air blowing unit can be accurately and effectively adjusted.

An image forming apparatus according to the present embodiment includes the above-mentioned paper feed mechanism, and can achieve the same effect as that achieved by the above-mentioned paper feed mechanism.

Although embodiments of the present invention have been described and illustrated in detail, the disclosed embodiments are made for purposes of illustration and example only and not limitation. The scope of the present invention should be interpreted by terms of the appended claims.

What is claimed is:

1. A paper feed mechanism comprising:
a paper storage to store sheets of paper;
an air blowing unit disposed on each of both sides of the paper storage in a second direction orthogonal to a first direction corresponding to a paper conveyance direction, wherein the air blowing unit blows air to a side end of each of the sheets of paper in the paper storage to float one or some of the sheets of paper in the paper storage; and
a paper conveyance unit disposed above the paper storage, wherein the paper conveyance unit holds, by suction, an uppermost sheet of paper among the floated sheets of paper, and conveys the uppermost sheet of paper, wherein
an air blowing position of the air blowing unit is changeable in the first direction according to information about the sheets of paper.

2. The paper feed mechanism according to claim 1, wherein
a lateral-side regulation unit for regulating sheets of paper is provided on each of both sides of the paper storage,
the air blowing unit is located in the lateral-side regulation unit, and
the lateral-side regulation unit is movable in the first direction.

3. The paper feed mechanism according to claim 1, wherein
a plurality of the air blowing units are provided, and
each of the air blowing units includes
an air blowing source,
a plurality of air outlets disposed side by side in the first direction,
a plurality of air flow paths that each connect a corresponding one of the air outlets to an air blowing port of the air blowing source, and
a blowing-air switching unit that switches each of the air flow paths to be opened and closed.

4. The paper feed mechanism according to claim 1, further comprising a detection unit, wherein
the detection unit detects information about sheets of paper stored in the paper storage, and
a control unit in cooperation with the detection unit adjusts at least one of the air blowing position and an air blowing amount according to a detection result of the detection unit.

5. The paper feed mechanism according to claim 4, wherein
the information about the sheets of paper includes at least one of a length, a thickness and a type of each of the sheets of paper.

6. The paper feed mechanism according to claim 1, wherein
a user is able to manually adjust the air blowing position.

7. The paper feed mechanism according to claim 1, wherein
a plurality of pairs of the air blowing units are provided to extend in the first direction, and
air blowing positions of at least one pair of the air blowing units are changeable in the first direction.

8. The paper feed mechanism according to claim 7, wherein
two pairs of the air blowing units are provided to extend in the first direction, and
a position of the air blowing unit located downstream in the paper conveyance direction is changeable.

9. The paper feed mechanism according to claim 1, wherein
the air blowing unit is moved in the first direction by a slide rail and a gear set.

10. An image forming apparatus comprising the paper feed mechanism according to claim 1.
